(19) United States
(12) Patent Application Publication
(10) Pub. No.: US 2012/0061164 A1
(43) Pub. Date: Mar. 15, 2012

(54) Power steering for a motor vehicle

(75) Inventors: Martin Budaker, Heubach (DE); Stephan Wanner, Schwaebisch Gmuend (DE); Arthur Rupp, Huettlingen (DE)

(73) Assignee: ZF Lenksysteme GmbH, Schwaebisch Gmuend (DE)

(21) Appl. No.: 13/317,399

(22) Filed: Oct. 17, 2011

Related U.S. Application Data
(63) Continuation of application No. PCT/EP2010/053101, filed on Mar. 11, 2010.

(30) Foreign Application Priority Data
Apr. 27, 2009 (DE) 10 2009 002 660.6

(51) Int. Cl. B62D 3/08; F16H 25/22

(52) U.S. Cl. 180/400; 74/89.36

(57) ABSTRACT

Disclosed is a power steering system for a motor vehicle, comprising a housing in which a steering rod is held in an axially movable manner. The steering rod comprises a spindle section which, together with a rotatably mounted recirculating ball nut forms a recirculating ball screw and nut gear. A support bushing is provided between an axial end of the steering rod and the recirculating ball nut, the bushing providing a through-hole for guiding the steering rod through. The inner face of the support bushing which faces the steering rod has a curved contour so that the opening cross-section of the through-hole increases toward the end of the steering rod. The curved contour is adapted to a bending line of the steering rod so that the steering rod, when it comes in contact with the support bushing as a result of a bending load, abuts the curved contour thereof in a planar manner.

### BACKGROUND OF THE INVENTION

The invention relates to a power steering system for a motor vehicle in which a steering rod is held in an axially movable manner.

A power steering system of this type is known from DE 103 10 492 A1.

A variety of power steering systems are known from the prior art, in which a steering rod or a toothed rack is mounted in a housing in an axially movable manner, wherein the steering rod comprises a spindle section which, together with a rotatably mounted recirculating ball nut, forms a recirculating ball screw and nut gear.

DE 103 10 492 A1 describes a power steering system, comprising a recirculating ball screw and nut gear, based on an example of an electric power steering system, in which the recirculating ball nut is driven by a belt drive connected to an electric motor. The electric power steering system of this type comprises a housing in which the steering rod, which is provided with a spindle section, is held in an axially movable manner. Together with a recirculating ball nut, the steering rod forms a recirculating ball screw and nut gear. An electric motor is disposed axially parallel to the steering rod, and transmits a force to the recirculating ball nut by means of a traction drive, for example a belt drive. The traction drive comprises, in the known manner, an input disk associated with the electric motor and an output disk associated with the recirculating ball nut, which are drivingly connected to each other by a traction means, which in the present example is a belt. The recirculating ball screw and nut gear converts the rotational movement of the electric motor into an axial movement of the steering rod, whereby the steering rod is displaced axially in the housing unit, or the steering gear housing, in accordance with the rotational direction of the electric motor. The axial displacement of the steering rod, moves the wheels of a motor vehicle which are connected to the steering rod, for example by way of tie rods, which is likewise known.

In conventional power steering systems, the movement and force are transmitted from the recirculating ball screw and nut gear, or the steering rod, to the wheels to be steered by tie rods. These tie rods typically do not run parallel to the axis of the recirculating ball nut or steering rod, but instead are at an articulation angle with respect to the same. As a result of various driving states or driving situations, various forces are introduced via the tie rods into the steering rod, with these forces being divided into radial and axial force components, because of the angles of the tie rods with respect to the steering rack. These forces may result in bending of the steering rods.

It is known from DE 10 2005 040 154 A1 to connect the recirculating ball nut to the housing by way of a special bearing, so that bending between the ball nut and the steering rod is reduced.

The problem with conventional steering racks or toothed racks is that the bending stress may result in plastic deformation of the steering rod. Supporting the steering rod is problematic because a cylindrical support bushing or bearing bushing would damage the threads of the steering rod, which is to say the spindle section. This is the case because, when the steering rod is deflected or bent, it abuts on the cylindrical bearing bushing, or the threads come in contact with the bearing bushing. This may result in wear on the steering rod and/or the bearing bushing. This damages the steering rod and/or the bearing bushing, and thus the function of the steering gear is impaired. Moreover, there is the risk of the toothed rack being snagged by the threads (spindle) in the cylindrical bearing bushing.

### SUMMARY OF THE INVENTION

It is the object of the present invention to substantially avoid wear and plastic deformation of the steering rod.

The bearing bushing or support bushing according to the invention reliably prevents plastic deformation of the toothed rack or steering rod. Because the opening cross-section of the through-hole of the support bushing increases toward the end of the steering rod, and the curved contour is adapted to a bending line of the steering rod, so that the steering rod, when it comes in contact with the support bushing as a result of a bending load, abuts on the curved contour thereof in a planar manner, damage to the steering rod and/or the support bushing as a result of contact, and/or wear occurring there, is reliably prevented. Because of the curved contour (bending curve contour), the solution according to the invention prevents linear contact of the steering rod on the support bushing, whereby the problems that would arise with a cylindrical bearing bushing are avoided.

The progression of the curved contour of the support bushing can be adapted to suit the associated steering rod. The steering rod diameter, the steering rod shape, the steering rod material and the like influence the bending line of the steering rod, and hence the curved contour of the support bushing. Moreover, the curved contour is dependent on the location in which the support bushing is disposed between the recirculating ball nut and the end of the steering rod. The resulting curved contour of the support bushing is relatively easy to calculate. The curved contour of the support bushing does not necessarily have to have a uniform progression. The curved contour can be any arbitrary mathematical structure which is patterned after the bending curve of the steering rod in the region with which the steering rod abuts the support bushing, when the steering rod is bent due to a bending load.

Because the bending line of the steering rod is dependent on the properties of the same, and moreover because the progression of the curved contour of the support bushing to be adapted thereto is also dependent on the arrangement of the support bushing, and optionally the cross-sectional surface area or the opening cross-section of the through-hole, individual calculations are required for each steering rod type.

It is advantageous for the through-hole to open toward the end of the steering rod in a funnel shape, and preferably in a uniform funnel shape. This allows for easy production of the support bushing. A preferably uniform funnel-shaped opening, however, is not absolutely necessary. Rather, it is also conceivable for the steering rod to have various bending lines as a result of bending in various radial directions, and thus for it to be advantageous for the support bushing to also have various curved contours in various radial directions.

According to the invention, the curved contour can be adapted to an extreme bending line of the steering rod, which results from a maximum permissible radial force acting on the end of the steering rod.

The maximum permissible radial force application can be determined for the respective vehicle-specific case, preferably individually, by determining the maximum lever length (maximum stroke), starting from the bearing point of the recirculating ball nut to the end of the steering rod, and the maximum force application (for example, when pushing off a curb). Care should be taken to ensure that the maximum travel of the steering rod does not exceed the limit of elasticity of the steering rod. Adapting the design of the curved contour to the extreme bending line ensures that the steering rod only abuts the curved contour of the support bushing when the extreme bending line of the steering rod is reached. Plastic deformation of the steering rod is prevented by the abutment on the curved contour.

If the steering rod is not subject to the maximum force application at the maximum lever length (which is to say, the maximum stroke), but rather in any arbitrary position, the steering rod will bend less severely because of the shorter lever length than at the maximum lever length. The steering rod will thus not be supported on the support bushing. Given the adaptation of the curved contour to the extreme bending line, the support bushing function is only used when the maximum force actually acts on the maximum lever length, which is to say at the end of the steering rod.

It is advantageous for the through-hole of the support bushing, and the arrangement of the support bushing between the recirculating ball nut and the end of the steering rod, to be selected such that the steering rod abuts the curved contour of the support bushing in a planar manner only when the extreme bending line is reached. It is further advantageous for the through-hole of the support bushing to have a further radius at the inlet and/or outlet, this radius being smaller than the radius of the curved contour.

This has the advantage that the steering rod cannot be snagged in the inlet or outlet region of the support bushing. Instead of a radius, a beveled edge or the like may be provided. Snagging at the inlet region or at the outlet region of the support bushing is preferably prevented by enhancing the curved contour in these regions, which is to say the curve radius is made smaller.

According to the invention, the support bushing can have a single-piece or a multi-piece design.

According to the invention, the support bushing can be composed of at least two parts. One part of the support bushing can then be designed as an insert or adapter, and another part of the support bushing can be designed as a support cheek. To this end, the outside diameter of the insert can be such that it makes it possible to position the insert in the housing surrounding the steering rod. This means, the outside diameter of the insert is adapted to the inside diameter of the region of the housing in which the support bushing is to be positioned. The insert preferably has a cylindrical inside diameter, which is adapted to the outside diameter of the support cheek, so that the support cheek can be positioned and fixed in the insert part. On the inner face, the support cheek has the curved contour according to the invention. The described multi-piece design of the support bushing has the advantage that the insert can be produced as a standard part. The insert can thus be used for various types of steering rods without modification. It suffices for the support cheek of the support bushing to be designed in a vehicle-specific manner or adapted to the respective steering rod. The production costs of the support bushing can thus be reduced.

According to the invention, the support bushing can moreover be designed integral with the housing. The support bushing can be formed by a portion of the housing. To this end, the support bushing, or the curved contour thereof, can be introduced into the inner face of the housing by turning or machining.

It is advantageous for the support bushing to be produced from wear-resistant material. The support bushing can preferably be made of plastic material or metal, for example steel.

Advantageous designs and refinements will be apparent from the remaining dependent claims. An exemplary embodiment of the invention is shown schematically hereafter based on the drawings.

### BRIEF DESCRIPTION OF THE DRAWINGS

FIG. 1 shows a basic illustration of a power steering system based on an electric power steering system, comprising a steering rod, a pinion having a torque sensor, an electric motor and a gear unit;

FIG. 2 shows a basic longitudinal section of an electric power steering system along the steering rod axis, without showing the support bushing according to the invention;

FIG. 3 is a basic illustration of the maximum travel or deflection of a steering rod;

FIG. 4 is a basic illustration of a travel of the steering rod prior to reaching the maximum travel;

FIG. 5 is a basic illustration of a support bushing according to the invention with one possible progression of the curved contour on the inner face of the through-hole;

FIG. 6 is a basic illustration of an additional support bushing according to the invention with one possible progression of the curved contour on the inner face of the through-hole;

FIG. 7 is a view of a support bushing in a two-piece design; and

FIG. 8 is a view of an additional support bushing in a two-piece design.

### DESCRIPTION OF THE PREFERRED EMBODIMENTS

Power steering systems for motor vehicles are sufficiently known from the general prior art, and here reference is made, for example, to DE 103 10 492 A1, so that hereafter only the characteristics that are essential for the invention will be addressed in more detail.

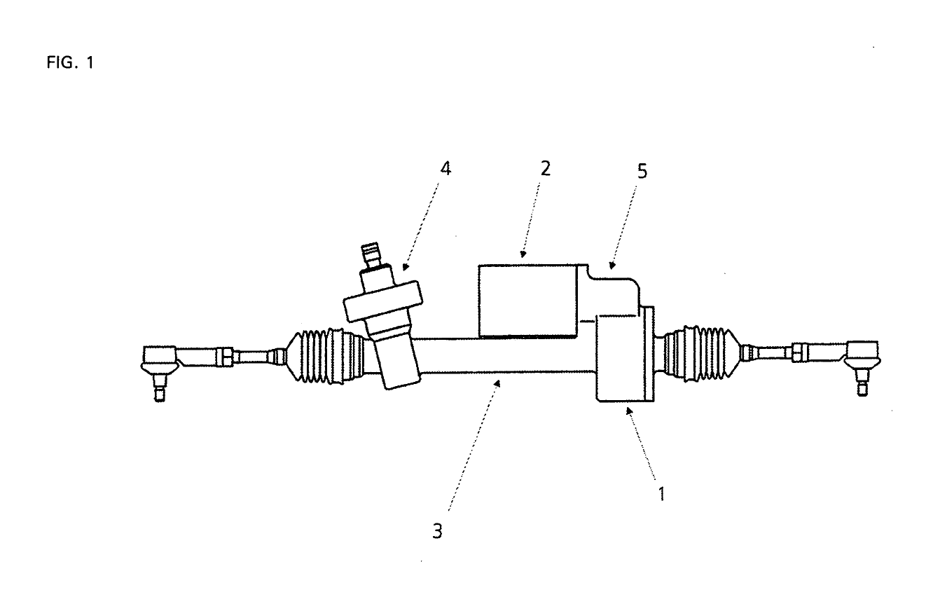

FIG. 1 shows a power steering system for motor vehicles, comprising a housing 1, an electric motor 2, and a steering rod 3 for moving vehicle wheels, which is not shown in detail. Moreover, the power steering system comprises a pinion having a torque sensor 4 and a gear unit 5, by means of which the steering rod 3 is drivingly connected to an output shaft 6 of the electric motor 2, the output shaft not being shown in detail in FIG. 2.

As is apparent from FIG. 2, the steering rod 3 is disposed parallel to the electric motor 2. On a teeth meshing section, which is not shown in FIG. 2, the steering rod 3 meshes with a pinion of a steering rod, the pinion likewise not being shown, and comprises an external thread on a spindle section 7. The spindle section 7 of the steering rod 3 is part of a recirculating ball screw and nut gear 8.

The spindle section 7 engages with a recirculating ball nut 9, which is also part of the recirculating ball screw and nut gear 8. The recirculating ball nut 9 is mounted in an axially fixed manner and forms a leading screw together with the steering rod 3. The recirculating ball nut 9 is non-rotatably connected to a driven disk 10 and mounted in the housing 1 by way of a bearing 11.

A driving disk 12 is fixed on the output shaft 6 of the electric motor 2. A traction means designed as a belt 13 is tensioned over the driven disk 10 and the driving disk 12 and, together with these disks, forms a traction drive. A force is transmitted from the electric motor 2 to the recirculating ball nut 9 via the traction drive.

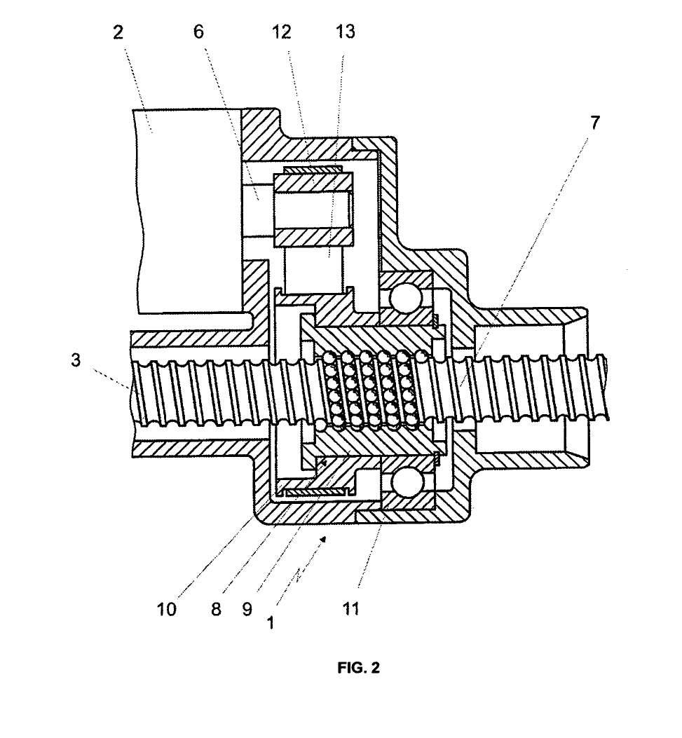

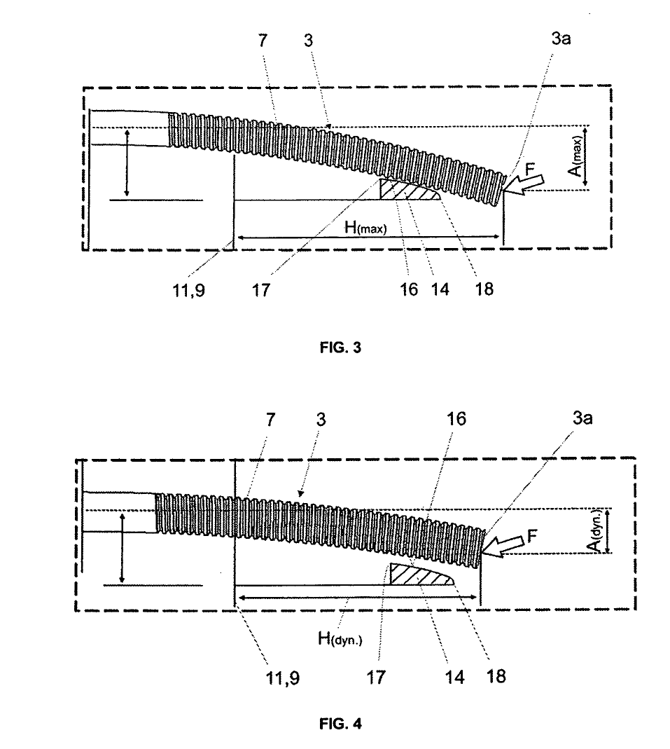

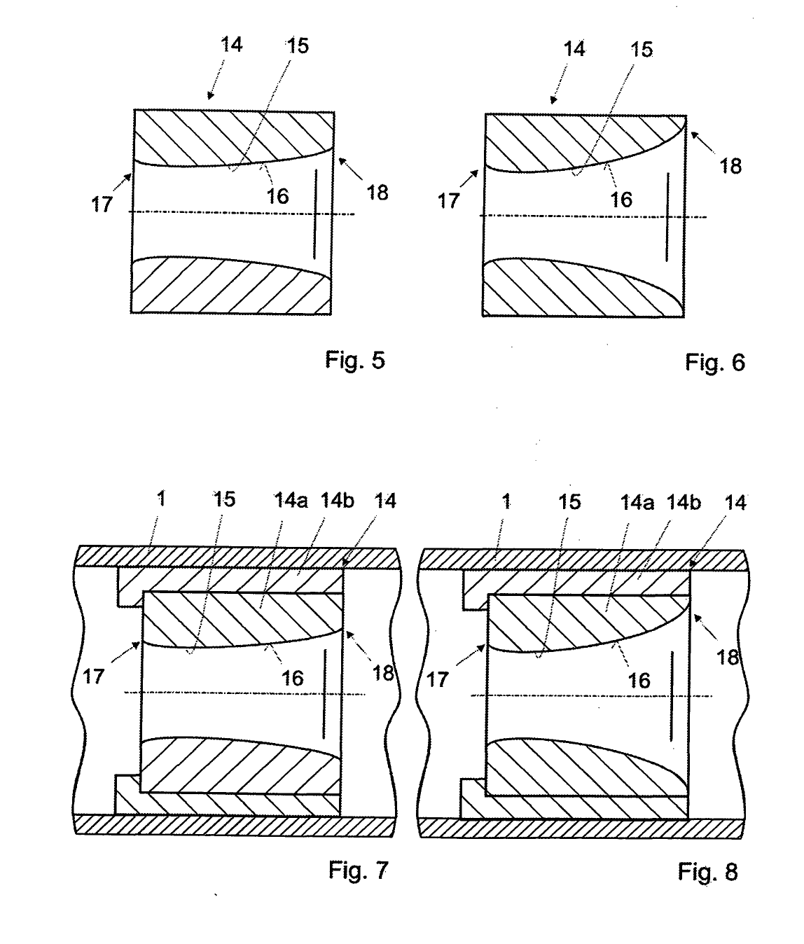

FIGS. 3 and 4 each show an end of the steering rod 3 and basic views of the position of the bearing point or the bearing 11 of the recirculating ball nut 9. Moreover, FIGS. 3 and 4 show basic views of a part of a support bushing 14 according to the invention. The support bushing 14 is disposed or designed between an axial end 3a of the steering rod 3 and the recirculating ball nut 9. One possible design of the support bushing 14 is shown in FIGS. 5 and 6.

As is apparent from viewing FIGS. 3 to 6 together, the support bushing 14 has a through-hole 15 for the steering rod 3 to pass through, or provides such a hole. The inner face 16 of the support bushing 14 which faces the steering rod 3 has a curved contour. The curved contour is designed so that the opening cross-section of the through-hole 15 increases toward the end 3a of the steering rod 3. The curved contour is adapted to a bending line of the steering rod 3 so that the steering rod 3, when it comes in contact with the support bushing 14 as a result of a bending load, abuts the curved contour thereof in a planar manner. Planar abutment of the steering rod 3 on the curved contour of the inner face 16 of the support bushing 14 is shown in a basic view in FIG. 3. The steering rod 3 preferably abuts over the entire length, or at least approximately the entire length of the support bushing 14. As an alternative, abutment is also possible over only a portion of the support bushing 14, as long as no linear contact that damages the threads of the steering rod 3 occurs.

FIG. 3 shows what is referred to as an extreme bending line of the steering rod 3. The curved contour of the support bushing 14 in the exemplary embodiment is adapted thereto. For this purpose, first the extreme bending line, which is to say the maximum travel of the steering rod 3, must be determined for the respective vehicle-specific case. The extreme bending line is ascertained from the maximum lever length H(max), which is to say the maximum stroke and the maximum force application F that occurs, for example, when pushing off a curb. The force is generally applied by the tie rod on the steering rod 3. This results in the maximum travel A(max). The maximum travel A(max) must not exceed the limit of elasticity of the steering rod 3 so as to prevent plastic deformation. Before plastic deformation is reached, the steering rod 3 abuts the curved contour of the inner face 16 of the support bushing 14 in a planar manner, as is shown in FIG. 3.

FIG. 4 shows the steering rod 3 in a position before it has reached the maximum travel A(max). This position is referred to as dynamic travel A(dyn) in FIG. 4.

If, as in the exemplary embodiment, the progression of the curved contour of the support bushing 14 is adapted to the extreme bending line, which is to say the maximum travel A(max), the steering rod 3 will not be supported on the support bushing 14 with travel below this value. FIG. 4 shows dynamic travel A(dyn) of the steering rod 3, in which the steering rod 3 is subjected to the maximum force application F at a lever length H(dyn). The lever length H(dyn) is thus less than the maximum lever length H(max), so that the steering rod 3, because of the shorter lever length, does not deflect so severely as to reach the maximum travel A(max). Only the travel A(dyn) is reached, so that the steering rod 3 does not abut the support bushing 14.

FIGS. 5 and 6 show two possible curved contours of the inner face 16. The curved contour that is required for the steering rod 3 to abut the curved contour of the support bushing 14 in a planar manner when the steering rod 3 is in contact with the support bushing 14 is derived from a variety of factors that vary depending on the vehicle, but can be calculated or determined by experimentation. The curved contour of the inner face 15 is derived from the bending line of the steering rod 3, which the rod has when the steering rod 3 is in contact with the support bushing 14. A curved contour of the support bushing 14 that is to be achieved is one that makes it possible for the steering rod 3 to rest closely against the inner face 16 of the support bushing 14, so that planar abutment takes place, with no linear support.

As is also apparent from FIGS. 5 and 6, at the inlet 17 and the outlet 18 of the bending curve contour, or of the support bushing 14, the support bushing 14 has a further curve, which in the exemplary embodiment is a radius that is smaller than the radius of the curved contour. This prevents the steering rod 3 from being snagged on entering or exiting the support bushing 14.

According to the exemplary embodiment, the support bushing 14 can have a one-piece (FIGS. 5 and 6) or multi-piece (FIGS. 7 and 8) design. Moreover, in a manner that is not shown, the support bushing 14 can be configured directly in the housing 1 by machining.

FIGS. 7 and 8 show one possible two-piece design of the support bushing 14 and the possible installation thereof in the housing 1.

As is apparent from FIG. 7 and FIG. 8, the support bushing 14 is divided into two parts, in terms of the functions thereof, these being a support cheek 14a and an insert 14b. The support cheek 14a ensures that the steering rod 3, when it is subjected to a bending load, abuts the inner face of the support cheek 14a in a planar manner. The insert 14b ensures reliable positioning of the support bushing 14 in the housing 1 surrounding the steering rod 3. The two-part design of the support bushing 14 has advantages in terms of production.

As is apparent from FIGS. 7 and 8, the insert 14b has a substantially cylindrical outside diameter and a substantially cylindrical inside diameter. Thus, the support bushing 14 forms a stop on the inner face, so that the support cheek 14a abuts this stop when the cheek is introduced in the insert 14b. The support cheek 14a has a cylindrical outside diameter, which substantially corresponds to the cylindrical inside diameter of the insert 14b, so that the support cheek 14a can be inserted in the insert 14b and fixed there. The inner face of the support cheek 14a, or the progression of the curved contour of the support cheek 14a, can be adapted to the bending line of the respective steering rod 3.

The outside diameter of the insert 14b is adapted to the inside diameter of the housing 1 surrounding the steering rod 3, so that the support bushing 14 can be fixed at the intended position. The outside diameter of the insert 14b thus substantially corresponds to the inside diameter of the housing 1 in this region.

The solution according to the invention is not limited to the illustrated use of the recirculating ball nut 9, or of the recirculating ball screw and nut gear as part of a power steering system having an axially parallel drive. Rather, the solution according to the invention can be used in any arbitrary recirculating ball screw and nut gear as part of a power steering system. The power steering system having the axially parallel drive shown in the exemplary embodiment merely represents a preferred field of use of the solution according to the invention.

### LIST OF REFERENCE NUMERALS

1 Housing
2 Electric motor
3 Steering rod
4 Pinion having a torque sensor
5 Gear unit
6 Output shaft
7 Spindle section
8 Recirculating ball screw and nut gear
9 Recirculating ball nut
10 Driven disk
11 Bearing
12 Driving disk
13 Belt (traction means)
14 Support bushing
14a Support cheek
14b Insert
15 Through-hole
16 Inner face
17 Inlet
18 Outlet

1. A power steering system for a motor vehicle, comprising a housing in which a steering rod is held in an axially movable manner, the steering rod comprising a spindle section which, together with a rotatably mounted recirculating ball nut forms a recirculating ball screw and nut gear, a support bushing provided between an axial end of the steering rod and the recirculating ball nut, said support bushing providing a through-hole for passing the steering rod through, wherein an inner face of the support bushing which faces the steering rod has a curved contour so that the opening cross-section of the through-hole increases toward an end of the steering rod and the curved contour is adapted to a bending line of the steering rod so that the steering rod, when it is in contact with the support bushing because of a bending load, abuts the curved contour in a planar manner.

2. The power steering system according to claim 1, wherein the curved contour is adapted to an extreme bending line of the steering rod which results from a maximum permissible radial force application on the end of the steering rod.

3. The power steering system according to claim 2, wherein the through-hole of the support bushing and the arrangement of the support bushing between the recirculating ball nut and the end of the steering rod are selected so that the steering rod abuts the curved contour of the support bushing in a planar manner only when the extreme bending line is reached.

4. The power steering system according to claim 1, wherein through-hole of the support bushing at an inlet and/or outlet has a further radius that is smaller than the radius of the curved contour.

5. A power steering system according to claim 1, wherein the through-hole opens in a funnel shape towards the end of the steering rod.

6. A power steering system according to claim 1, wherein the support bushing has a single-piece design.

7. A power steering system according to claim 1, wherein the support bushing has a multi-piece design.

8. The power steering system according to claim 7, wherein the support bushing comprises at least one insert for inserting into the housing surrounding the steering rod and a support cheek for inserting into the insert.

9. A power steering system according to claim 1, wherein the support bushing is integrally formed with the housing.

10. The power steering system according to claim 9, wherein the support bushing is formed by a portion of the housing.

11. The power steering system according to claim 9, wherein the curved contour is introduced in the inner face of the housing by turning.

12. A power steering system according to claim 1, wherein the support bushing comprises a wear-resistant material.

13. A support bushing according to claim 1 for a power steering system of a motor vehicle, comprising a steering rod having a spindle section which, together with a rotatably mounted recirculating ball nut, forms a recirculating ball screw and nut gear.
